(19) United States
(12) Patent Application Publication
(10) Pub. No.: US 2007/0269203 A1
(43) Pub. Date: Nov. 22, 2007

(54) Image-taking system and image-taking apparatus

(75) Inventor: Kouhei Awazu, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, MINATO-KU (JP)

(21) Appl. No.: 11/797,974

(22) Filed: May 9, 2007

(30) Foreign Application Priority Data
May 19, 2006 (JP) 2006-140446

(51) Int. Cl. G03B 19/00

(52) U.S. Cl. 396/429

(57) ABSTRACT

A digital camera includes a light-emitting section provided with LEDs that emit fill light. The digital camera also includes a visible-light transmission section that transmits data representing a live view or data representing shooting information, after superimposing the data on light emitted from the LEDs by modulating the light. The transmitted data is received by a visible-light reception section of a mobile telephone that displays an image on its display screen based on the received data.

### BACKGROUND OF THE INVENTION

1. Field of the Invention

The present invention relates to an image-taking apparatus that generates image data by capturing an image of a subject, and to an image-taking system that includes the image-taking apparatus and performs transmission and reception of visible light.

2. Description of the Related Art

Thanks to recent developments of light-emitting diodes (LED) that emit blue light, LEDs are now used in traffic signals. In addition, since emission of white light has become now possible by means of LEDs emitting blue light, LEDs emitting red light and LEDs emitting green light. LEDs are also used in lighting fixtures, electric lamps, etc. Use of LEDs in traffic signals, lighting fixtures, etc. makes it possible to reduce power consumption, thereby securing electronic power required for the future. Each of such traffic signals, lighting fixtures, etc. employs multiple LEDs and thus, there is proposed a technique for utilizing such multiple LEDs (for example, see Website, URL:http://www.katayama.nuee.nagoya-u.ac.jp/works/OC/). In this technique, a visible-light transmitter, which blinks at least one of LEDs at such a high speed that no human eye can recognize the blinking, is mounted on a device such as a traffic signal or a lighting fixture, thereby implementing a communication function in the device.

Meanwhile, LEDs are also used in the field of image-taking device. Specifically, an LED is employed as an auxiliary light source in an image-taking device in place of a xenon tube, in order to reduce power consumption as well as the size and weight of the image-taking device (for example, see Japanese Patent Application Publication No. 2004-271981).

### SUMMARY OF THE INVENTION

The present invention has been made in view of the above circumstances, and provides an image-taking system that utilizes a portable apparatus and an image-taking apparatus used in the image-taking system.

A first image-taking system according to the invention includes:

an image-taking apparatus that generates image data by capturing an image of a subject, and includes a visible-light emission section that emits visible light to the subject and a visible-light transmission section that transmits data after superimposing the data on the light emitted from the visible-light emission section by modulating the light; and

a portable apparatus that includes a visible-light reception section that receives the data superimposed on the light emitted from the visible-light emission section of the image-taking apparatus.

According to the first image-taking system, the visible-light transmission section of the image-taking apparatus transmits data by visible light, and the transmitted data is received by the visible-light reception section of the portable apparatus.

For example, a recent image-taking apparatus has LEDs as a light source of a flashing device or an autofocus fill-light emitter. Accordingly, it is possible to implement the image-taking apparatus of the invention by using the LEDs as the visible-light emission section and adding the visible-light transmission section, thereby transmitting data by superimposing the data on visible light emitted from the LEDs to the portable apparatus carried by a person whose image is captured by the image-taking apparatus.

Also, a recent portable apparatus such as a mobile telephone often has a communication section such as an infrared reception section. Accordingly, it is possible to add the visible-light reception section to such a portable apparatus in a similar fashion, so that the first image-taking system of the invention can be implemented by combining the portable apparatus with the image-taking apparatus of the invention.

Further, because the portable apparatus such as a mobile telephone used in the first image-taking system usually has a display screen and a speaker, it is possible to provide visible information and sound information to a person carrying the portable apparatus by displaying an image on the display screen and by sending out sound through the speaker based on the data transmitted from the image-taking apparatus.

In the first image-taking system, a person carrying the portable apparatus can confirm shooting information transmitted from the image-taking apparatus with the display screen and/or the speaker.

An image-taking apparatus according to the invention generates image data by capturing an image of a subject, and includes:

a visible-light emission section that emits visible light to a subject; and

a visible-light transmission section that transmits data after superimposing the data on the light emitted from the visible-light emission section by modulating the light.

According to the image-taking apparatus of the invention, if a person carrying the portable apparatus provided with the visible-light reception section of the invention is within reach of the light from the visible-light emission section, it is possible to provide the person with shooting information.

The image-taking apparatus used in the first-image taking system of the invention can be thus realized.

The image-taking apparatus may have a self-timer function of taking an image upon a lapse of a fixed period of time after a shooting instruction, and

the visible-light transmission section may transmit data representing time remaining before shooting.

Also, the image-taking apparatus according to the invention may generate moving-image data before shooting and generates still-image data obtained by the shooting, and
the visible-light transmission section may transmit the moving-image data.

These additional features make it possible to provide pre-shooting information such as the remaining time and framing to a person carrying the portable apparatus.

In the image-taking apparatus according to the invention, the visible-light transmission section may transmit information for notifying completion of shooting.

This additional feature makes it possible to provide a person carrying the portable apparatus with post-shooting information such as completion of a shooting in addition to the pre-shooting information.

The image-taking apparatus according to the invention may generate still-image data in response to a shooting instruction, and

the visible-light transmission section may transmit the still-image data.

A recent portable apparatus often has a memory for storing image data and thus, it is convenient if the portable apparatus is configured to store sill-image data in the memory.

However, if still-image data is transmitted as it is, it is very likely that transmission of the data will take a long time or result in a failure due to insufficient capacity of the memory, because the size of the transmitted data is too large.

The image-taking apparatus according to the invention may further include an image compression section that compresses the still-image data and generates the compressed image data, and
the visible-light transmission section may transmit the compressed image data.

In the image-taking apparatus according to the invention, the visible-light emission section may further include an LED, and
the visible-light transmission section may transmit data to an external receiving end by blinking the LED based on the data.

Further, in the image-taking apparatus according to the invention, preferably, the visible-light transmission section transmits data by causing the LED to start blinking before shooting and to keep blinking until the shooting is completed, while causing the LED to emit visible light to the subject, thereby notifying the subject that the shooting is going to take place and the shooting is underway.

Furthermore, in the image-taking apparatus according to the invention, preferably, when the visible-light transmission section is transmitting data by blinking the LED before shooting, the image-taking apparatus uses light emitted from the LED as autofocus fill light.

Still furthermore, in the image-taking apparatus according to the invention, preferably, the visible-light transmission section transmits data by causing the LED to blink while switching among three states of an off state, a low-intensity state, and a high-intensity state.

A second image-taking system according to the invention includes:

a fixed lighting apparatus that emits visible light to a subject and has a visible-light transmission section that transmits data after superimposing the data on the light by modulating the light;

a fixed image-taking apparatus that generates image data by capturing an image of a subject and supplies the lighting apparatus with data to be transmitted; and

a portable apparatus that includes a visible-light reception section that receives the data superimposed on the light emitted from the lighting apparatus.

According to the second image-taking system of the invention, image data generated based on shooting by the fixed image-taking apparatus is supplied to the visible-light transmission section of the lighting apparatus, and then transmitted therefrom to the portable apparatus and received by the visible-light reception section of the portable apparatus.

For example, the image-taking apparatus may be fixed at each exhibition booth in an exhibition hall, and information such as shooting timing and image data generated by the image-taking apparatus at the time of shooting may be constantly supplied to the lighting apparatus and transmitted from the lighting apparatus to the portable apparatus. In this case, it is possible to provide the shooting timing and framing information as well as image data to visitors who visit the booth and each carry the portable apparatus.

As described above, according to the invention, it is possible to realize the image-taking system using the portable apparatus and the image-taking apparatus used in the system, by slightly modifying the portable apparatus commonly used.

### BRIEF DESCRIPTION OF THE DRAWINGS

FIG. 1 is a diagram showing an image-taking system and a digital camera used in the image-taking system according to a first embodiment of the invention;

FIG. 2 is a block diagram showing an internal configuration of the digital camera shown in FIG. 1;

FIG. 3 is a diagram showing transitions of light emitted from LEDs, while a communication section is modulating the light by repeatedly turning on and off the LEDs;

FIG. 4 is a flowchart showing a procedure of shooting processing performed by a system control circuit of the digital camera shown in FIG. 2;

FIG. 5 is a perspective view showing the front of a mobile telephone;

FIG. 6 is a perspective view showing the back of the mobile telephone;

FIG. 7 is a block diagram showing an internal configuration of the mobile telephone whose external views are shown in FIGS. 5 and 6;

FIG. 8 is a diagram showing an effect produced when moving-image data is transmitted from the digital camera;

FIG. 9 is a diagram showing another digital camera implemented by modifying the digital camera shown in FIG. 2;

FIG. 10 is a diagram showing an effect produced when two or more users each carry the digital camera shown in FIG. 9;

FIG. 11 is a diagram showing an image-taking system according to a second embodiment of the invention;

FIG. 12 is a block diagram showing an internal configuration of the digital camera shown in FIG. 11;

FIG. 13 is a flowchart showing a procedure of shooting processing performed in the digital camera shown in FIG. 12; and

FIG. 14 is a diagram showing a modification of the image-taking system shown in FIG. 11; and

FIG. 15 is a flowchart showing a procedure of shooting and transmission processing executed in the digital camera shown in FIG. 14.

### DETAILED DESCRIPTION OF THE INVENTION

Embodiments of the present invention will be described with reference to the drawings.

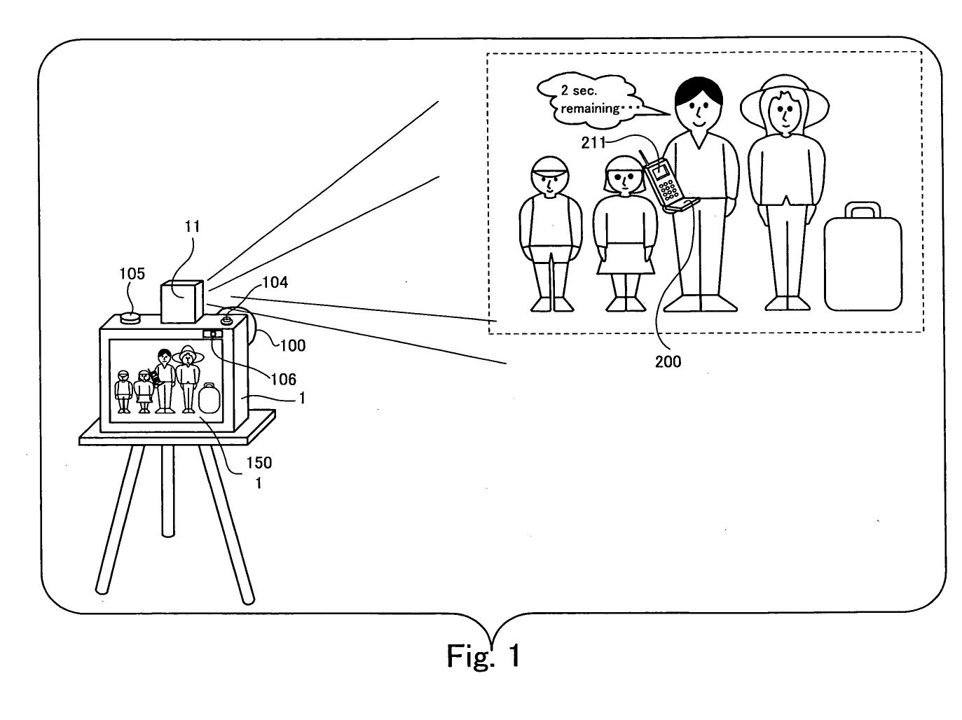

FIG. 1 is a diagram showing an image-taking system and a digital camera 1 used in an image-taking system according to a first embodiment of the invention. FIG. 1 shows an external view of the digital camera 1.

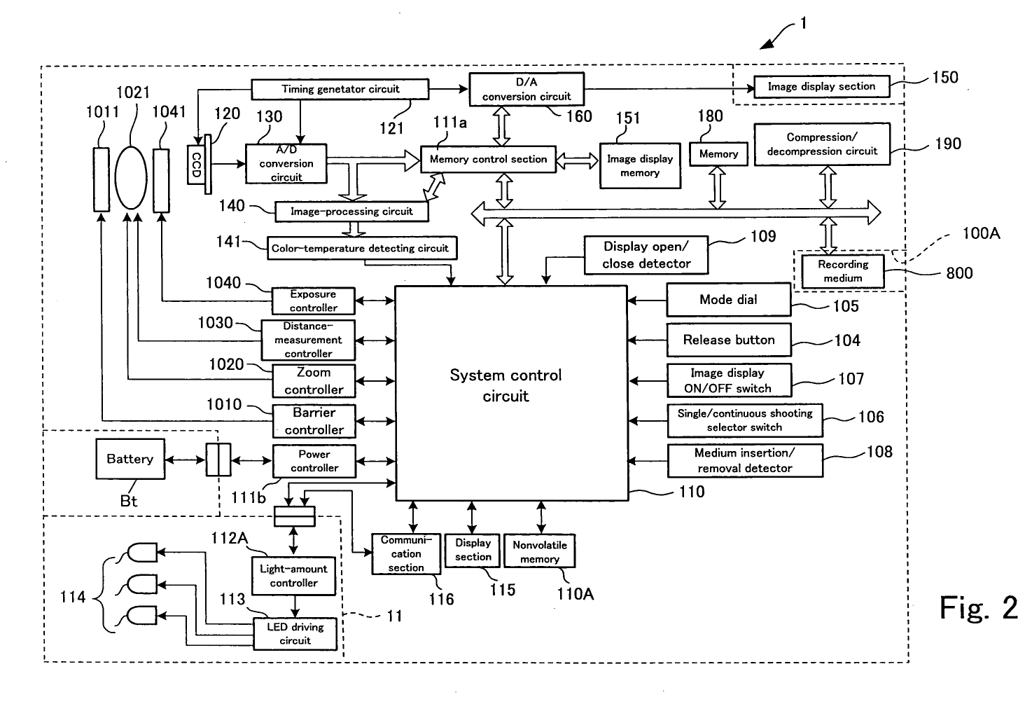

The image-taking system shown in FIG. 1 includes the digital camera 1 and a mobile telephone 200. The digital camera 1 shown in FIG. 1 has an example of the “visible-light transmission section” in the first image-taking system of the invention, while the mobile telephone 200 has an example of the “visible-light reception section” in the first image-taking system of the invention. The respective structures and operations of the visible-light transmission section and the visible-light reception section will be described later with reference to FIG. 2.

First, the structure of the digital camera 1 in the present embodiment will be briefly described.

The digital camera 1 shown in FIG. 1 has a lens barrel 100 with a built-in shooting lens. The digital camera 1 also has, on the top of the camera body thereof, a light-emitting section 11 that emits fill light for shooting. The light-emitting section is configured to emit visible light such that data to be transmitted is superimposed on the visible light. FIG. 1 also shows operation members such as a release button 104, a mode dial 105, and a single/continuous shooting selector switch 106.

Meanwhile, the mobile telephone 200 has a visible-light reception section disposed therein as will be described later, which receives data transmitted from the digital camera 1. For example, when the visible-light reception section receives image data transmitted from the digital camera 1, an image (corresponding to an area surrounded by a dotted line shown in FIG. 1) represented by the received image data is displayed on a display screen 211 of the mobile telephone 200. In addition, the digital camera 1 of the present embodiment has a self-timer mode as one of shooting modes. In the self-timer mode, shooting can be executed upon a lapse of a fixed period of time after a shooting instruction. In this mode, the light-emitting section 11 of the digital camera 1 can also transmit data representing the time (second) remaining until shooting as a piece of shooting information. Therefore, in the example shown in FIG. 1, an image represented by image data as well as the remaining time are both displayed on the display screen 211.

FIG. 2 is a block diagram showing an internal configuration of the digital camera 1 shown in FIG. 1.

The internal configuration of the digital camera 1 will be described below with reference to FIG. 2.

In the digital camera 1 of the present embodiment, a system control circuit 110 controls all the processing. To an input section of the system control circuit 110, operation members such as the release button 104, the mode dial 105 and the single/continuous shooting selector switch 106 are connected. When an operation signal, which is generated in response to any of these operation members being operated, is supplied to the system control circuit 110, processing corresponding to at least one of the operation members being operated begins.

The digital camera 1 of the present embodiment has a removable recording medium 800 such as a memory card and a medium chamber 100A into which the recording medium 800 can be removably inserted, although they are not shown in FIG. 1. When the recording medium 800 is inserted into the medium chamber 100A, image data representing a shot image can be recorded in the recording medium 800. The digital camera 1 also has a medium insertion/removal detector 108 capable of detecting whether the recording medium 800 is inserted into the medium chamber 100A or not. Further, the digital camera 1 has an image display ON/OFF switch 107 disposed on the back thereof although it is not shown in FIG. 1, and a display open/close detector 109 capable of detecting an open/closed status of a protection cover that protects the surface of a display screen 1051, which is disposed on the back of the digital camera 1 (see FIG. 1), by covering it. The system control circuit 110 is configured to execute processing upon receipt of a signal from any of the image display ON/OFF switch 107, the medium insertion/removal detector 108, and the display open/close detector 109 as required. The system control circuit 110 is also configured to cause, in response to a zoom switch (not shown) being operated, a zoom controller 1020 to move a zoom lens of a shooting lens group 1021 according to the operation.

Also, the system control circuit 110 performs through-the-lens (TTL) distance measurement as well as TTL metering based on image data generated in a CCD solid imaging device (herein after referred to as CCD) 120. Based on a result of the TTL metering, the system control circuit 110 causes an exposure controller 1040 to control the aperture of a diaphragm 1041. At the time of shooting, the system control circuit 110 causes a light-amount controller 112A to control a LED driving circuit 113 based on a result of the TTL metering, so that the LED driving circuit 113 causes LEDs 114 to emit a predetermined amount of fill light for shooting toward a subject.

The system control circuit 110 includes a white-balance adjustment section, a gamma (γ) correction section, a YC conversion section, and the like. The white-balance adjustment section is provided to adjust white balance based on a color temperature detected by a color-temperature detecting circuit 141. The γ correction section is provided to perform gamma correction so as to produce a signal suitable for specifications of the display screen 1051 provided in an image display section 150. The YC conversion section is provided to convert RGB signals, which have been subjected to γ correction, into YC signals, so that an image can be displayed on any type of display section.

In the present embodiment, the digital camera 1 has a communication section 116 that is an example constituting part of the “visible-light transmission section” in the first image-taking system of the invention. The communication section 116 causes the light-amount controller 112A to blink the LEDs 114, thereby transmitting data representing shooting information to the mobile telephone 200 by means of visible-light communication before, during and after shooting. The details will be described later.

Now, operation of the digital camera 1 will be briefly described with reference to FIG. 2.

Upon turning on of a power switch (now shown) of the digital camera 1, the system control circuit 110 starts shooting processing by controlling the entire operation of the digital camera 1 according to a procedure described in an overall-processing program stored in a nonvolatile memory 110A. In this example, in order to save the power of a battery Bt, the system control circuit 110 is so configured as to supply the power to each block from the battery Bt via a power controller 111b, only when the power switch (not shown) of the digital camera 1 is turned on and then the turning on of the power switch is detected by the system control circuit 110. Note that the power from the battery Bt is constantly supplied to the system control circuit 110.

With reference to FIG. 2, there will be briefly described the configuration and operation of the digital camera 1 in the active state with the power being thus supplied to each block.

Disposed in the lens barrel 100 shown in FIG. 1 are elements such as the shooting lens group 1021 including the focus lens and zoom lens and the diaphragm 1041 for adjusting the amount of light as shown in FIG. 2. In addition, a lens barrier 1011 for protecting the lenses is provided in the example shown in FIG. 2. Upon turning on of the power switch, the system control circuit 110 causes a barrier controller 1010 to open the lens barrier 1101 so that the shooting lens group 1021 is exposed.

If the mode dial 105 is in the shooting mode when the power switch is turned on, a subject image passing through the exposed shooting lens group 1021 is formed on the CCD 120. Subsequently, image data representing the formed image is output from the CCD 120 to an A/D conversion circuit 130, after the data is thinned out at predetermined intervals (of 16.5 ms, for example) based on a timing signal output from a timing generator circuit 121. The image data is then subjected to analog-to-digital conversion by the A/D conversion circuit 130. Subsequently, under the control of a memory control section 111a, the digital image data thus obtained is transmitted to an image-processing circuit 140 where the image data (RGB data) is divided into R-color signals, G-color signals, and B-color signals. The RGB signals thus obtained are then sent to the color-temperature detecting circuit 141 and the system control circuit 110 through a bus, under the control of the memory control section 111a. The color-temperature detecting circuit 141 detects a color temperature of the signals and supplies information representing the detected temperature to the system control circuit 110, so that the white-balance adjustment section of the system control circuit 110 can adjust the white-balance of the signals based on the color temperature.

After the white-balance adjustment by the white-balance adjustment section, the gamma (γ) correction section of the system control circuit 110 applies gamma correction to the signals, so that an image based on the signals can be displayed on the display screen 1501 (see FIG. 1) of the digital camera 1. The RGB signals are then converted into YC signals by a YC signal converter and stored in an image display memory 151. The YC signals thus stored in the image display memory 151 are read out for one frame under the control of the memory control section 111a and sent to a D/A conversion circuit 160. The YC signals for one frame are then converted into analog image data by the D/A conversion circuit 160 and supplied to the image display section 150.

In this example, the image display memory 151 is provided to supply new image data at predetermined intervals to the image display section 150. Image data for at least two frames can be stored in the image display memory 151, which makes it possible to well adjust the timing for supplying image data to the image display section 150, thereby displaying a moving image formed by image data continuously and smoothly supplied at predetermined intervals.

In the present embodiment, while executing processing for a moving image, the system control circuit 110 causes the light-emitting section 11 to emit light from the LEDs 114. Simultaneously, the system control circuit 110 supplies image data representing the moving image to the communication section 116, so that the communication section 116 can superimpose the image data on light emitted from the LEDs 114 and then transmit the image data by controlling the light-amount controller 112A and the LED driving circuit 113 to an external device such as the mobile telephone 200.

For example, if there is a person with the mobile telephone 200 (described later) who is within reach of the light emitted from the LEDs 114 and an image of the person is going to be taken with the digital camera 1, moving-image data is transmitted from the digital camera 1 to the mobile telephone 200 as shooting information and an image is displayed on a display screen of the mobile telephone 200 based on the moving-image data.

Besides image data representing a moving image, the digital camera 1 of the present embodiment is configured to transmit data such as data representing the time (second) remaining before shooting when the self-timer mode (which will be described later) is selected and data representing a still image obtained by shooting.

Now, shooting processing that starts in response to a press of the release button 104 will be described.

As described above, the system control circuit 110 performs TTL distance measurement, and instructs a distance-measurement controller 1030 to constantly move the focus lens of the shooting lens group 1021 to a focus position based on a result of the TTL distance measurement. Also, the system control circuit 110 instructs, in response to the zoom switch being operated by a user, the zoom controller 1020 to move the zoom lens of the shooting lens group 1021 to a position according to a magnification set through the zoom switch 106 by the user. Accordingly, a moving image in constant focus and according to a magnification indicated by the zoom switch is displayed on the display screen 1501 (see FIG. 1). Upon a half press of the release button 104 by the user looking at the displayed moving image, the system control circuit 110 starts shooting processing as described below.

In response to a half press of the release button 104, the system control circuit 110 performs metering with a metering section incorporated therein, and determines whether light emission for shooting is necessary or not based on a result obtained by the metering. If the system control circuit 110 determines here that light emission is unnecessary, the system control circuit 110 gives no instruction to the light-emitting section 11 and continues the shooting processing. In contrast, if the system control circuit 110 determines here that light emission is necessary, the system control circuit 110 prepares for causing the LEDs 114 to emit light for shooting in synchronous with a full press of the release button 104, under the control of the light-amount controller 112A of the light-emitting section 11.

After shooting is thus prepared, the system control circuit 110 instructs the timing generator circuit 121 to supply an exposure-starting signal to the CCD 120 in response to a full press of the release button 104, so that the CCD 120 starts exposure. When light emission for shooting is necessary, the system control circuit 110 instructs the light-amount controller 112A to let the LED driving circuit 113 drive the LEDs 114, thereby causing the LEDs 114 to emit light for shooting. After a fixed period of time has elapsed based on a shutter speed (second), the system control circuit 110 instructs the timing generator circuit 121 to supply an exposure-ending signal to the CCD 120.

In synchronous with the exposure-ending signal, image data is output from the CCD 120 to the A/D conversion circuit 130 upon completion of the exposure. The image data is then subjected to a conversion from analog to digital by the A/D conversion circuit 130, and the digital image data thus obtained is supplied to a memory 180 under the control of the memory control section 111a via a bus. After the image data formed by all the pixels of the CCD 120 is stored in the memory 180, the stored image data is readout and subjected to white balance adjustment by the white-balance adjustment section of the system control circuit 110, under the control of the system control circuit 110. The image data is then subjected to gamma correction and converted into YC signals, and supplied to a compression/decompression circuit 190 via a bus, where the image data of YC signals is compressed. Subsequently, the compressed image data is stored into the recording medium 800, which is a memory card in this embodiment.

In the digital camera 1 of the present embodiment, the compressed image data is also supplied to the communication section 116, so that the communication section 116 can superimpose the image data on visible light emitted from the LEDs 114 and transmit the superimposed image data by controlling the light-amount controller 112A and the LED driving circuit 113. If the subject of shooting is a person carrying the mobile telephone 200 provided with a visible-light reception section, the person can save an image shot by and received from the digital camera 1 in his/her own mobile telephone 200.

The digital camera 1 shown in FIG. 1 includes a display section 115 for displaying the contents of user operation as shown in FIG. 2, although it is not shown in FIG. 1.

In this way, the system control circuit 110 controls the shooting operation of the digital camera 1, and still-image data obtained by shooting can be recorded in the recording medium 800 such as a memory card and saved as well in a portable device carried by a person who is the subject of an image represented by the still-image data.

Next, there will be described features of the light-emitting section 11 that is provided in the digital camera 1 shown in FIG. 2 and corresponds to an example of the “visible-light emission section” in the first image-taking system of the invention.

As described above, the digital camera 1 of the present embodiment is provided with the communication section 116 for communicating with an external device or the like, and the communication section 116 causes the light-amount controller 112A to blink the LEDs 114 at a high speed, anytime before, during and after shooting, thereby transmitting data to an external receiving end. In the present embodiment, the light-emitting section 11 is an example of the “visible-light emission section” in the first image-taking system of the invention, while the combination of the light-emitting section 11 and the communication section 116 serves as an example of the “visible-light transmission section” in the first image-taking system of the invention.

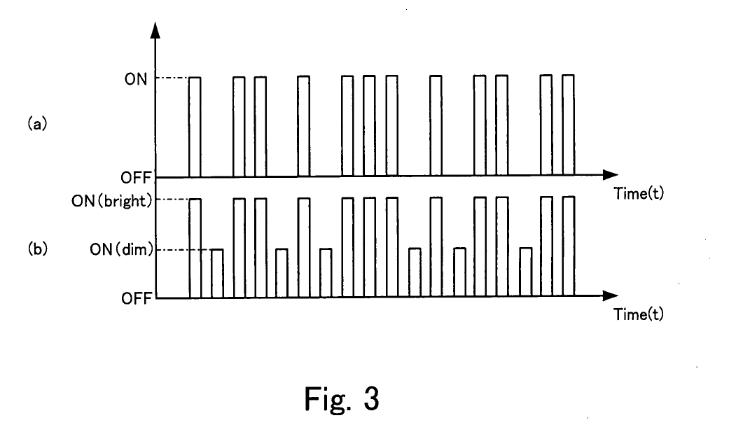

FIG. 3 is a diagram showing transitions of light emitted from the LEDs 114 while the communication section 116 is modulating the light by repeatedly turning on and off the LEDs 114. The light from the LEDs 114 is modulated in such a manner that upon receipt of to-be-transmitted data from the system control circuit 110, the communication section 116 causes the light-amount controller 112A and the LED driving circuit 113 of the light-emitting section 11 to blink the LEDs 114 at a high-speed according to the received data.

Part (a) of FIG. 3 shows an example in which the light-amount controller 112A and the LED driving circuit 113 periodically blink the LEDs 114 at a high speed in accordance with an instruction from the communication section 116.

As shown in part (a) of FIG. 3, when data is transmitted by modulation of light emitted from the LEDs 114 in accordance with an instruction from the communication section 116, a receiving end receives the data by discriminating between ON state and OFF state of the light, and obtains digital data composed of “0” and “1” by demodulating the received data. As mentioned above, the LEDs 114 is caused to blink at such a high speed (a modulation speed defining a blinking cycle) that no human eye can recognize the blinking and thus, it is possible to transmit a large amount of data such as image data.

Further, even if the LEDs 114 start blinking in the manner shown in FIG. 3 before shooting, the blinking of the light is invisible to human eyes and thus it appears as if the light remains on. Accordingly, it is possible to produce such an effect that a person or people as a subject can be aware that shooting is about to take place. In addition, it is possible to use light from the LEDs 114 as autofocus (AF) fill light emitted before shooting.

Incidentally, although the two states, ON state and OFF state, are respectively allocated to “0” and “1” data in the example shown in part (a) of FIG. 3, an intermediate state may be set between ON state and OFF state. Specifically, as shown in part (b) of FIG. 3, data may be sent by switching among three states of ON state, Dim state and OFF state, which makes it possible to increase an amount of information to be sent at a time and thus reduce data-transmission time.

In this way, the system control circuit 110 causes the light-emitting section 11 to emit light from the LEDs 114 and simultaneously causes the communication section 116 to control the high-speed turning on and off of the LEDs 114, so that the light on which the data is superimposed can be emitted to the mobile telephone 200. Accordingly, it is possible to provide shooting information to a person carrying a portable device similar to the mobile telephone 200 provided with the visible-light reception section.

This concludes the description of the structure and operation of the digital camera 1 shown in FIG. 1.

Now, by means of a flowchart, there will be described functions of the “visible-light transmission section” in the first image-taking system of the invention, which is exemplified by the combination of the light-emitting section 11 and the communication section 116 in the present embodiment.

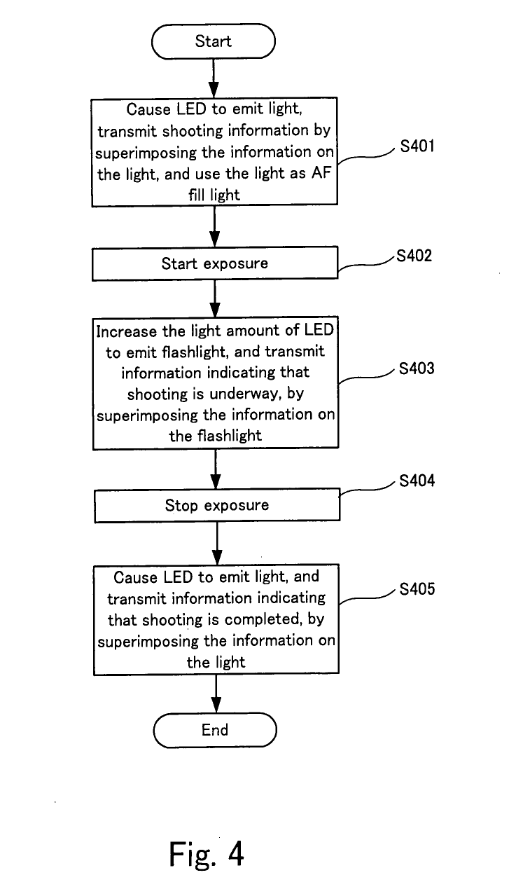

FIG. 4 is a flowchart showing a procedure of shooting processing executed by the system control circuit 110. The procedure in this flowchart starts upon selection of the self-timer mode of the digital camera 1.

At step S401, when causing the LEDs 114 of the light-emitting section 11 to emit light, the system control circuit 110 also causes, via the communication section 116, the light-amount controller 112A of the light-emitting section 11 to transmit shooting information (such as the time remaining before shooting and data representing an image of a subject) by superimposing the data on visible light emitted from the LEDs 114. Then, the system control circuit 110 measures a distance with a TTL distance measurement section disposed therein, by using the light emitted from the LEDs 114 before shooting as AF fill light and adjusts the focus based on the measured distance. Subsequently, at step S402, the system control circuit 110 starts exposure by instructing the timing generator circuit 121 to supply an exposure-starting signal to the CCD 120.

Subsequently, at step S403, the system control circuit 110 causes the LEDs 114 to emit flashlight, and also provides the communication section 116 with data indicating the current status that the shooting is underway. The communication section 116 superimposes the received data on the flashlight and transmits the superimposed data to the mobile telephone 200.

Subsequently, at step S404, the system control circuit 110 stops exposure and causes the CCD 120 to output image data, by instructing the timing generator circuit 121 to supply an exposure-ending signal to the CCD 120. The flow then proceeds to step S405 where the system control circuit 110 causes the LEDs 114 to emit light and provides the communication section 116 with data indicating that the shooting is completed. The communication section 116 superimposes the received data on the light and then transmits the data to the mobile telephone 200. Then, the processing in this flow ends.

Execution of the processing in this flowchart makes it possible to precisely provide shooting information to a person carrying a portable device similar to the mobile telephone 200 provided with the visible-light reception section.

Now, there will be described the structure of the mobile telephone 200 used in combination with the digital camera 1.

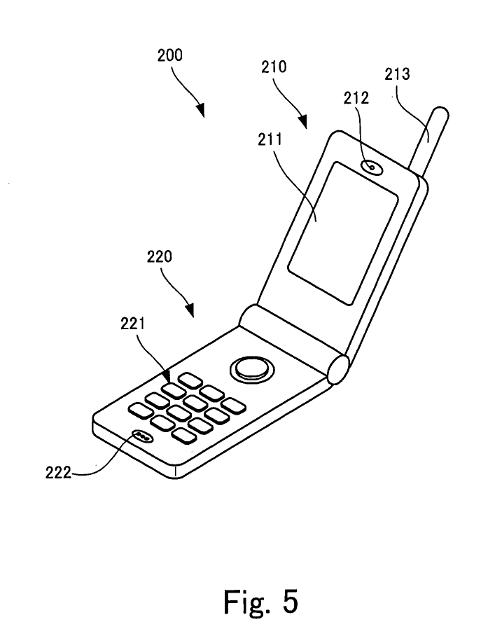

FIGS. 5 through 7 are diagrams showing the structure of the mobile telephone 200.

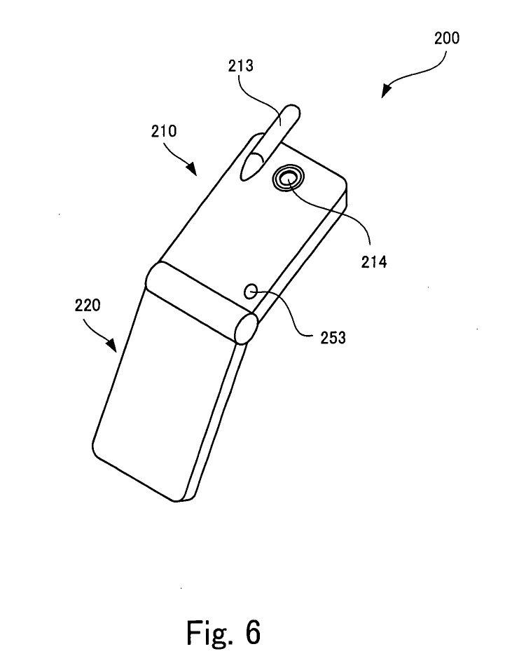

FIGS. 5 and 6 are perspective views showing the front and the back of the mobile telephone 200, respectively.

The mobile telephone 200 is a folding telephone, which is composed of an upper unit 210 and a lower unit 220.

The upper unit 210 of the mobile telephone 200 is provided with a display screen 211, an earpiece 212, an antenna 213, and a camera lens 214 disposed on the back of the upper unit 210. The lower unit 220 is provided with an operation key group 221 and a mouthpiece 222. As shown in FIG. 6, the upper unit 210 is also provided with a visible-light reception section 253 on the back thereof.

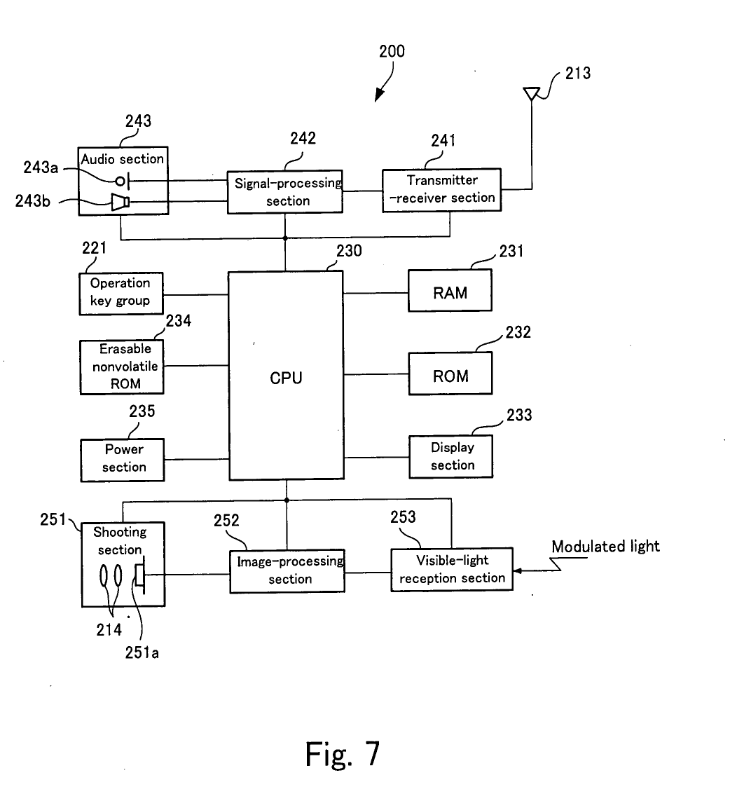

FIG. 7 is a block diagram showing an internal configuration of the mobile telephone 200 whose external views are shown in FIGS. 5 and 6.

The mobile telephone 200 is configured such that a CPU 230 controls the entire operation of the mobile telephone 200. Provided around the CPU 230 are a volatile RAM 231, a nonvolatile ROM 232, a display section 233 provided with the display screen 211 (see also FIG. 5), the operation key group 221 (see also FIG. 5), an erasable nonvolatile ROM 234, and a power section 235.

The ROM 232 is provided to store information such as programs executed by the CPU 230, and the erasable ROM 234 is provided to store programs downloaded through packet communication. The CPU 230 controls each component of the mobile telephone 200 by executing the programs stored in the ROM 232 and the erasable ROM 234. The RAM 231 is used as a work area for transmitting data to an external receiving end.

The display section 233 is provided with the display screen 211 and displays an image on the display screen 211 according to a command from the CPU 230. Also, the CPU 230 executes processing according to user operation carried out through the operation key group 221.

The power section 235 is an element onto which a battery (now shown) is loaded, and the power from the battery is supplied to the CPU 230 and each component of the mobile telephone 200 under the control of the CPU 230.

In addition to the antenna 213 shown in FIGS. 5 and 6, the mobile telephone 200 has a transmitter-receiver section 241, a signal-processing section 242, and an audio section 243, so as to implement functions as a telephone. The audio section 243 includes a microphone 243a disposed inside the mouthpiece 222 and a speaker 243b disposed inside the earpiece 212.

The transmitter-receiver section 241 is a circuit element that transmits and receives radio waves via the antenna 213. A signal obtained through radio reception via the antenna 213 and input to the signal-processing section 242 is subjected to signal processing therein, and then output as sound from the speaker 243b of the audio section 243. Meanwhile, sound picked up by the microphone 243a of the audio section 243 is subjected to signal processing in the signal-processing section 242, and then transmitted from the transmitter-receiver section 241 via the antenna 213 by radio wave.

The mobile telephone 200 is also provided with a packet communication function. A packet signal received by the transmitter-receiver section 241 via the antenna 213 through packet communication is subjected to appropriate signal processing in the signal-processing section 242, and temporarily stored in the RAM 231 or stored in the erasable ROM 234 if the signal is a downloaded program. Upon receipt of an instruction from the operation key group 221, the CPU 230 displays data represented by the packet signal stored in the RAM 231 on the display screen 211 of the display section 233 or executes the program stored in the erasable ROM 234.

A document or the like for packet communication can be created through the operation key group 221 and temporarily stored in the RAM 231 right after being created. In response to an instruction from the operation key group 221 requesting transmission of the document, the document is sent to the signal-processing section 242 and subjected to signal processing therein, and then transmitted from the transmitter-receiver section 241 via the antenna 213 by radio wave.

The mobile telephone 200 is also provided with a shooting section 251 and an image-processing section 252 to perform the function of shooting an image.

The shooting section 251 includes a shooting lens group 214 shown in FIG. 5 and an image pick-up device 251a. When an image of a subject is formed on the image pick-up device 251a through the shooting lens group 214, image data representing the image is generated by the image pick-up device 251a. The image data generated by the image pick-up device 251a is processed by the image-processing section 252 and converted into digital image data. The digital image data is then temporarily stored in the RAM 231 and displayed on the display screen 211 of the display section 233 in response to user operation performed through the operation key group 221.

The mobile telephone 200 having the above-described functions further includes a visible-light reception section 253. Data transmitted from an external transmitting end through visible-light communication is received by the visible-light reception section 253 and temporarily stored in the erasable ROM 234 or the RAM 231. The stored data can be read out from the erasable ROM 234 or the RAM 231, and supplied to the transmitter-receiver section 241 to be transmitted to an external receiving end, or supplied to the display section 233 to be displayed on the display screen 211 (see FIG. 5) as an image.

When the digital camera 1 shown in FIG. 2 and the mobile telephone 200 shown in FIGS. 5 through 7 described so far are combined, there is implemented an image-taking system where shooting information can be transmitted from the digital camera 1 to the mobile telephone 200 carried by a person within reach of light emitted from the LEDs 114 of the digital camera 1.

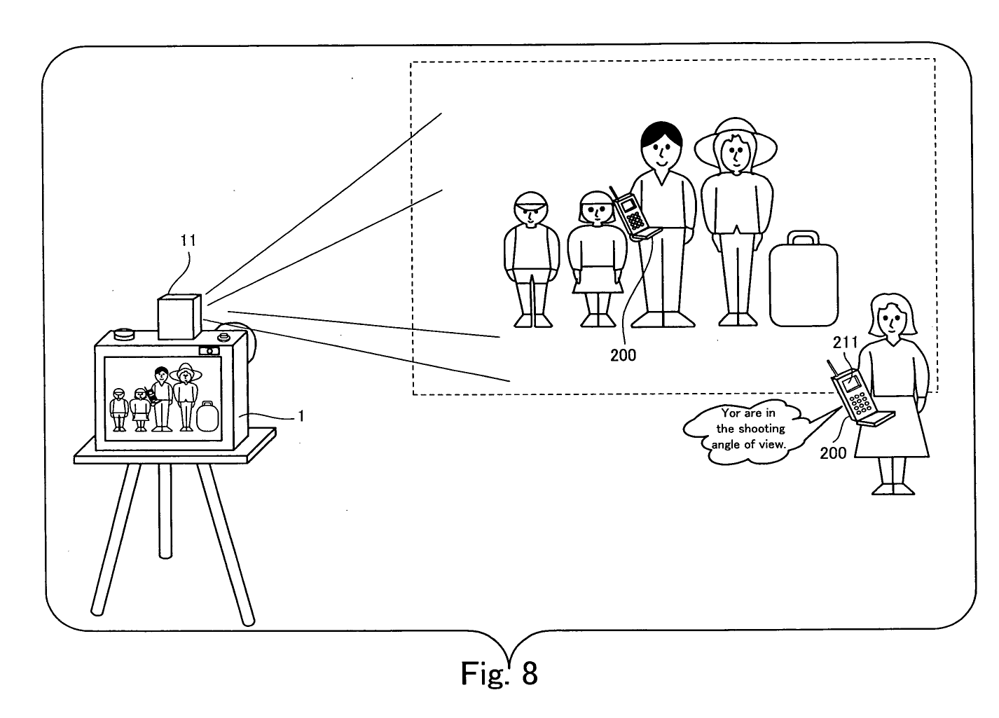

FIG. 8 is a diagram showing an effect produced when moving-image data is transmitted from the digital camera 1 to the mobile telephone 200.

As shown in FIG. 8, when moving-image data transmitted from the digital camera 1 is received by the mobile telephone 200, the mobile telephone 200 can display a moving image on the display screen 211 based on the received data. Accordingly, there is obtained such an effect that a person carrying the mobile telephone 200 can see exactly where the person is standing, by receiving visible light with the mobile telephone 200, because data representing a moving image currently captured by the digital camera 1 is superimposed on the received light.

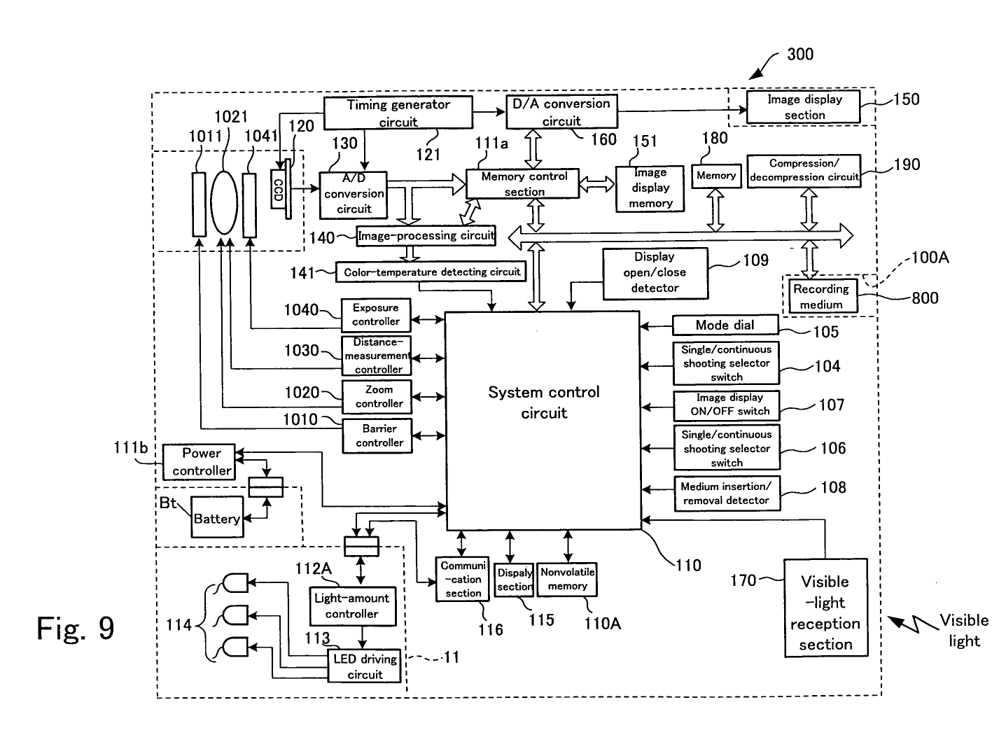

FIG. 9 is a diagram showing a digital camera 300 implemented by modifying the digital camera 1 shown in FIG. 2. The digital camera 300 is similar to the digital camera 1 except that a visible-light reception section 170 is added.

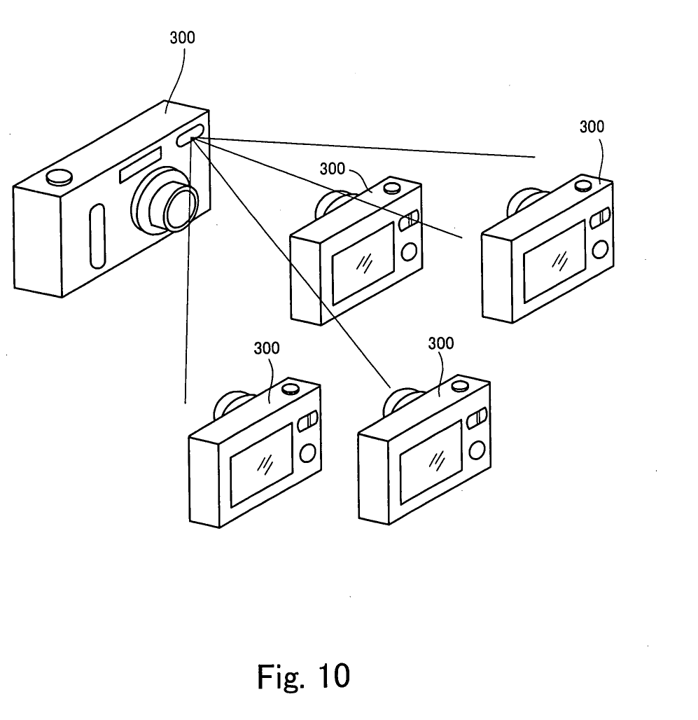

FIG. 10 is a diagram showing an effect produced when two or more users each carry the digital camera 300 shown in FIG. 9.

In the digital camera 300 shown in FIG. 9, data transmitted by visible light from an external transmitting end is received by the visible-light reception section 170 and recorded in a recording medium (memory card) 800 or a nonvolatile memory 110A under the control of a system control circuit 110.

Therefore, for example, after shooting is performed by the digital camera 300 carried by one of the users, image data obtained by the shooting can be transmitted through visible light communication to the digital cameras 300 carried by the rest of the users as shown in FIG. 10.

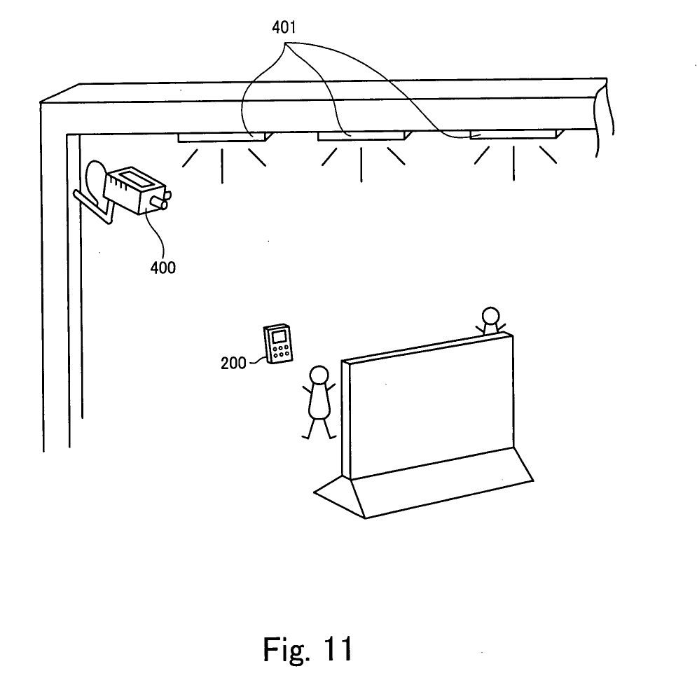

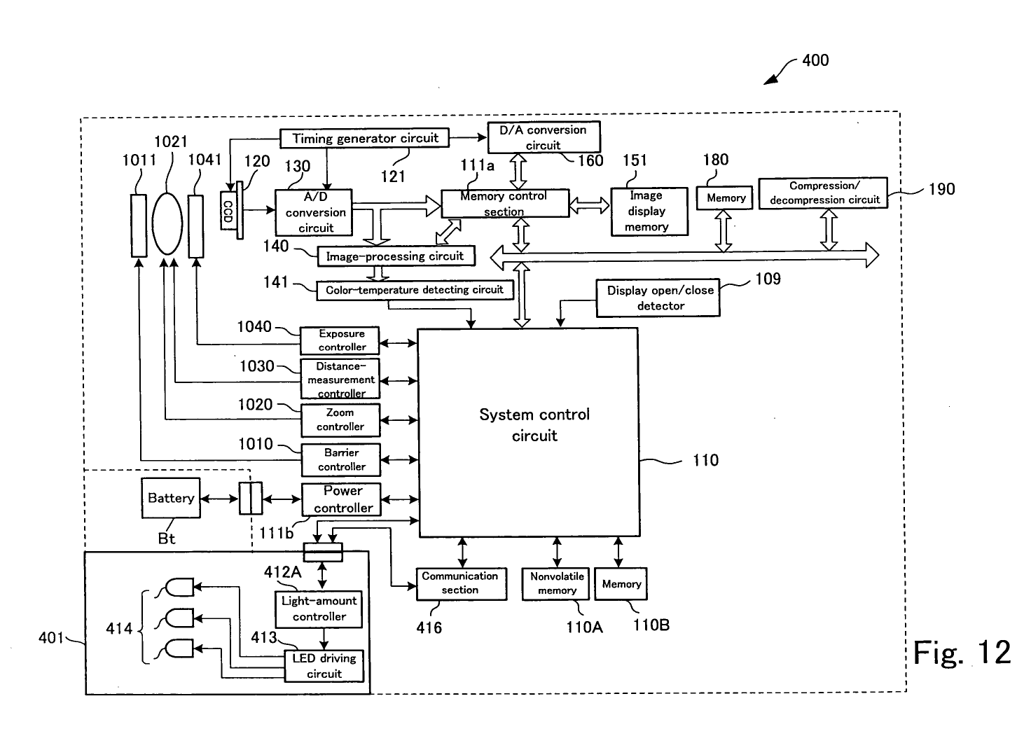

FIGS. 11 and 12 are diagrams showing an image-taking system according to a second embodiment of the invention.

FIG. 12 is a block diagram showing an internal configuration of a digital camera 400 shown in FIG. 11.

The digital camera 400 shown in FIG. 12 is a fixed type of camera and thus operation members such as a release button are removed. Otherwise, the internal configuration of the digital camera 400 is similar to that of the digital camera 1 shown in FIG. 2.

When the digital camera 400 is fixed as shown in FIG. 11, it is possible to use a lighting device 401 disposed near the digital camera 400 as a visible-light emission section, instead of providing a visible-light emission section in the digital camera 400. In this case, an example of the “visible-light transmission section” in the second image-taking system of the invention is provided in the lighting device 401. When the lighting device 401 has LEDs 414 as shown in FIG. 12, the image-taking system in this embodiment can be implemented only by slightly modifying the configuration shown in FIG. 2.

FIG. 12 shows an example realized by removing the light-emitting section 11 from the digital camera 1 shown in FIG. 2. In this example, the digital camera 400 and the lighting device 401 are connected via a network, and the lighting device 401 is an example of the “visible-light emission section” in the second image-taking system of the invention.

In this example, it is possible to transmit data to a target present anywhere within reach of the light from the lighting device 401 shown in FIG. 11. In the example shown in FIG. 12, one lighting device 401 is connected to the digital camera 400 (only connectors are shown at a connection point in FIG. 12). However, actually, multiple lighting devices 401 are connected to the digital camera 400 as shown in FIG. 11.

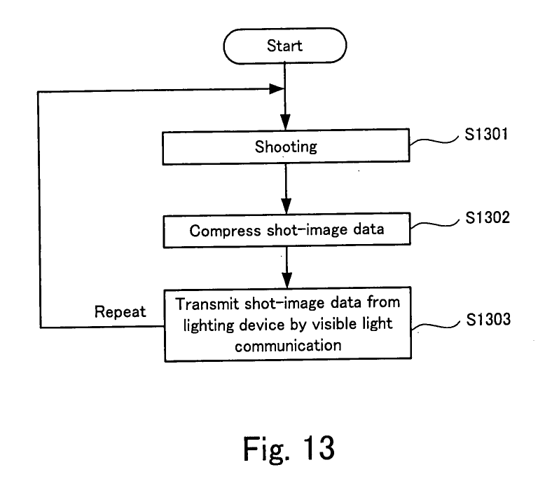

FIG. 13 is a flowchart showing a procedure of shooting processing performed by the system control circuit 110 shown in FIG. 12. In the flowchart shown in FIG. 13, shooting is carried out at predetermined intervals and shot images are sequentially transmitted.

First, shooting is performed at step S1301, and image data obtained by the shooting is compressed at step S1302. Subsequently, at step S1303, the compressed image data is supplied from a communication section 416 to the lighting device 401, and transmitted after being superimposed on light emitted from the LEDs 414. The flow then returns to step S1301 and repeats a cycle of steps 1301 through 1303. In this way, image data is transmitted to a portable device carried by a person at predetermined intervals, thereby providing the person with the image data.

Execution of the processing in this flowchart makes it possible, for example, to shoot an image of a person while the person is standing in front of an exhibit, and to provide the person with the shot image by transmitting image data representing the shot image to a portable device carried by the person after the shooting.

Incidentally, although processing before shooting is not shown in FIG. 13, the system control circuit 110 is configured to display a through image (live view) on a display screen before shooting, and thus a photographer can look at the through image and recognize the right time for shooting.

A place such as an exhibition hall is often crowded with visitors and thus, it is preferable to sequentially shoot images.

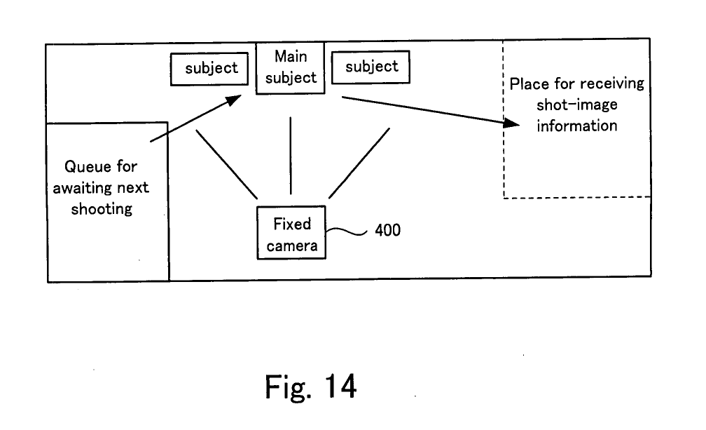

FIG. 14 is a diagram showing a modification of the image-taking system shown in FIG. 11, suitable for such a situation.

In this case, the digital camera 400 may be fixed as shown in FIG. 14, and configured to perform shooting at predetermined intervals. The digital camera 400 transmits image data obtained by the shooting to each person who was a subject of the shot image, when the person arrives at a place for receiving shot-image information.

According to this modification, there is realized an image-taking system that can shoot images of crowded visitors and smoothly provide the shot images to the respective visitors.

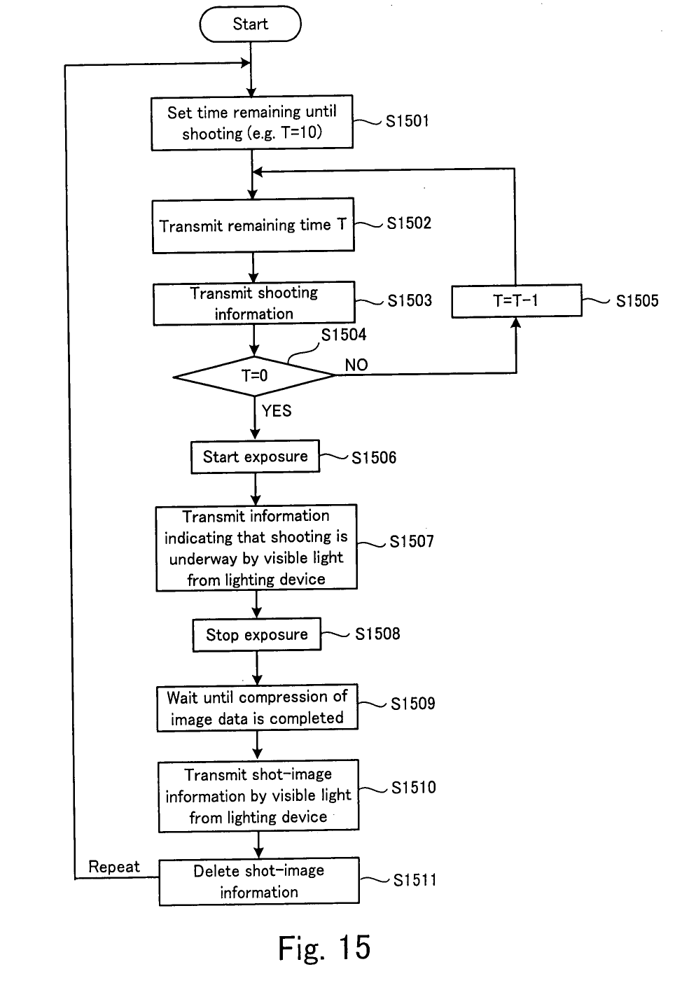

FIG. 15 is a flowchart showing a procedure of shooting and transmission processing executed by the system control circuit 110 of the digital camera 400, which realizes the image-taking system shown in FIG. 14.

At step S1501, the system control circuit 110 determines time T, which is the time remaining until shooting. At step S1502, the system control circuit 110 causes the communication section 416 to supply data representing the time T to the lighting device 401, so that the data is superimposed on light emitted from the LEDs 414 of the lighting device 401 and then transmitted to a portable device. Subsequently, at step S1503, the system control circuit 110 causes the communication section 416 to supply data representing shooting information such as a white balance and an aperture value to the lighting device 401, so that the data is superimposed on light emitted from the LEDs 414 and then transmitted to the portable device. The flow then proceeds to step S1504 where it is determined whether the time T is zero or not, i.e. whether it is time to perform shooting or not. If it is determined that the time T is not zero at step S1504, the flow proceeds to step S1505 where the system control circuit 110 decrements the time T by one (T−1), and returns to step S1502 and repeats the processing therefrom.

On the contrary, if it is determined that the time T is zero at step S1504, the flow proceeds to step S1506 where the system control circuit 110 instructs the timing generator circuit 121 to supply an exposure-starting timing signal to the CCD 120, so that the CCD 120 starts exposure. Subsequently, at step S1507, the system control circuit 110 causes the communication section 416 to supply data indicating that the shooting is underway to the lighting device 401, so that the data is superimposed on light emitted from the LEDs 414 and transmitted from the lighting device 401. At this point, it is preferable to use part of the LEDs 414 in order to prevent the shooting from being affected.

The flow then proceeds to step S1508 where after a fixed period of time, the system control circuit 110 causes the timing generator circuit 121 to supply an exposure-ending timing signal to the CCD 120, so that the CCD 120 stops exposure and outputs image data. Subsequently, at step S1509, the system control circuit 110 causes the compression/decompression circuit 190 to compress the image data and waits until a fixed period of time elapses. After the fixed period of time, the system control circuit 110 causes the communication section 416 to supply the compressed image data to the lighting device 401, so that the data is superimposed on light emitted from the LEDs 414 and transmitted from the lighting device 401 at step S1510. The flow then proceeds to step S1511 where the image data transmitted at step S1510 is deleted, and returns to step S1501 where the system control circuit 110 starts processing for the next image data.

The image-taking system shown in FIG. 14 is effective, for example, in a situation where visitors are crowded in an exhibition hall, because the system can reduce a long waiting time.

What is claimed is:

1. An image-taking system comprising:
an image-taking apparatus that generates image data by capturing an image of a subject, and includes a visible-light emission section that emits visible light to the subject and a visible-light transmission section that transmits data after superimposing the data on the light emitted from the visible-light emission section by modulating the light; and
a portable apparatus that includes a visible-light reception section that receives the data superimposed on the light emitted from the visible-light emission section of the image-taking apparatus.

2. An image-taking apparatus that generates image data by capturing an image of a subject, comprising:
a visible-light emission section that emits visible light to a subject; and
a visible-light transmission section that transmits data after superimposing the data on the light emitted from the visible-light emission section by modulating the light.

3. The image-taking apparatus according to claim 2, wherein the image-taking apparatus has a self-timer function of taking an image upon a lapse of a fixed period of time after a shooting instruction, and
the visible-light transmission section transmits data representing time remaining before shooting.

4. The image-taking apparatus according to claim 2, wherein the image-taking apparatus generates moving-image data before shooting and generates still-image data obtained by the shooting, and
the visible-light transmission section transmits the moving-image data.

5. The image-taking apparatus according to claim 2, wherein the visible-light transmission section transmits information for notifying completion of shooting.

6. The image-taking apparatus according to claim 2, wherein the image-taking apparatus generates still-image data in response to a shooting instruction, and
the visible-light transmission section transmits the still-image data.

7. The image-taking apparatus according to claim 6, further comprising an image compression section that compresses the still-image data and generates the compressed image data, and
the visible-light transmission section transmits the compressed image data.

8. The image-taking apparatus according to claim 2, wherein the visible-light emission section further includes an LED, and
the visible-light transmission section transmits data to an external receiving end by blinking the LED based on the data.

9. The image-taking apparatus according to claim 8, wherein the visible-light transmission section transmits data by causing the LED to start blinking before shooting and to keep blinking until the shooting is completed, while causing the LED to emit visible light to the subject, thereby notifying the subject that the shooting is going to take place and the shooting is underway.

10. The image-taking apparatus according to claim 8, wherein when the visible-light transmission section is transmitting data by blinking the LED before shooting, the image-taking apparatus uses light emitted from the LED as autofocus fill light.

11. The image-taking apparatus according to claim 8, wherein the visible-light transmission section transmits data by causing the LED to blink while switching among three states of an off state, a low-intensity state, and a high-intensity state.

12. An image-taking system comprising:
a fixed lighting apparatus that emits visible light to a subject and has a visible-light transmission section that transmits data after superimposing the data on the light by modulating the light;
a fixed image-taking apparatus that generates image data by capturing an image of a subject and supplies the lighting apparatus with data to be transmitted; and
a portable apparatus that includes a visible-light reception section that receives the data superimposed on the light emitted from the lighting apparatus.
